(19) United States
(12) Patent Application Publication
(10) Pub. No.: US 2020/0045534 A1
(43) Pub. Date: Feb. 6, 2020

(54) DISTRIBUTED WIRELESS ENCRYPTION NETWORKS, DEVICES, AND METHODS

(71) Applicant: CABLE TELEVISION LABORATORIES, INC., Louisville, CO (US)

(72) Inventors: Darshak Thakore, Broomfield, CO (US); John C. Bahr, Superior, CO (US)

(21) Appl. No.: 16/530,677

(22) Filed: Aug. 2, 2019

Related U.S. Application Data
(60) Provisional application No. 62/713,686, filed on Aug. 2, 2018.

(51) Int. Cl. H04W 12/00; H04W 12/04; H04W 36/00

(52) U.S. Cl. CPC H04W 12/001; H04W 84/18; H04W 36/0038; H04W 12/04031

(57) ABSTRACT

A method for distributed wireless encryption includes (a) establishing, at a first wireless access point (WAP), a first encrypted wireless communication link between the first WAP and a first device, (b) receiving, at the first WAP, an encrypted data packet from the first device via the first encrypted wireless communication link, and (c) forwarding the encrypted data packet from the first WAP to a first node within the first local area network (LAN), without decrypting the encrypted data packet.

### RELATED APPLICATIONS

This application claims benefit of priority to U.S. Provisional Patent Application Ser. No. 62/713,686, filed on Aug. 2, 2018, which is incorporated herein by reference.

### BACKGROUND

Wireless communication networks have become very common. For example, wireless communication networks operating according to an Institute of Electrical and Electronics Engineers (IEEE) 802.11 standard, often referred to as “Wi-Fi” networks, are frequently found in homes and in businesses.

However, data transmitted by a wireless communication network can potentially be intercepted by a third party, which may present a security risk. Consequently, data transmitted by a wireless communication network is typically encrypted to prevent unauthorized access to the data. For example, data transmitted between a station and a wireless access point (WAP) is typically encrypted, such as according to a Wi-Fi Protected Access 2 (WPA2) protocol or a Wi-Fi Protected Access 3 (WPA3) protocol. Specifically, data to be transmitted from the station to the WAP is encrypted before leaving the station, and the data is decrypted upon arrival at the WAP. Similarly, data to be transmitted from the WAP to the station is encrypted before leaving the WAP, and the data is decrypted upon arrival at the station. It has also been proposed to encrypt data flowing between a station and a cloud virtual network function (VNF) outside of a local area network (LAN) of the station and the WAP.

### BRIEF DESCRIPTION OF THE DRAWINGS

FIG. 1 is a block diagram of a LAN supporting distributed wireless encryption, according to an embodiment.

FIG. 2 is a block diagram of an embodiment of the FIG. 1 LAN including a thin WAP.

FIG. 3 is a block diagram of a thin WAP, according to an embodiment.

FIG. 4 is a block diagram of another thin WAP, according to an embodiment.

FIG. 5 is a block diagram of an embodiment of the FIG. 1 LAN including a WAP configured to selectively decrypt data packets before forwarding the data packets to an upstream node.

FIG. 6 is a flow chart illustrating a method for selectively decrypting data packets, according to an embodiment.

FIG. 7 is a block diagram of another embodiment of the FIG. 1 LAN including a WAP configured to selectively decrypt data packets before forwarding the data packets to an upstream node.

FIG. 8 is a flow chart illustrating another method for selectively decrypting data packets, according to an embodiment.

FIG. 9 is a block diagram of an embodiment of the FIG. 1 LAN supporting device roaming by transmitting an encryption key among WAPs.

FIG. 10 is a block diagram of an alternate embodiment of the FIG. 1 LAN where a WAP is replaced with a thin WAP.

FIG. 11 is block diagram of an alternate embodiment of the FIG. 1 LAN supporting distributed wireless encryption among a plurality of WAPs configured as a mesh network.

FIG. 12 is block diagram of an alternate embodiment of the FIG. 1 LAN including a plurality of WAPs communicatively coupled to a gateway device in a star configuration.

FIG. 13 is block diagram of an alternate embodiment of the FIG. 1 LAN including a plurality of Internet of Things (IoT) devices, where each IoT device includes an instance of the FIG. 2 thin WAP.

FIG. 14 is a block diagram of an alternate embodiment of the FIG. 1 LAN including a secure WAP and a plurality of thin WAPs.

FIG. 15 is a block diagram illustrating an alternative operating scenario of the FIG. 14 LAN.

### DETAILED DESCRIPTION OF THE EMBODIMENTS

Conventional Wi-Fi networks may have significant drawbacks. For example, conventional Wi-Fi networks often provide inadequate coverage, particularly in larger buildings or in buildings constructed of materials that block wireless signal transmission. Wi-Fi coverage can be improved by deploying multiple WAPs, such as in a mesh network configuration, but conventional WAPs are relatively expensive. Additionally, conventional Wi-Fi mesh networks may be incapable of achieving desired coverage and/or performance.

The present systems and methods help solve one or more of the problems discussed above. Disclosed herein are networks, devices, and methods which distribute wireless encryption operations. For example, in certain embodiments of a LAN, a WAP establishes a wireless communication link with a first device, such as user equipment. The WAP, however, does not necessarily decrypt encrypted data packets that it receives from the first device via the encrypted wireless communication link. Instead, the WAP may forward the encrypted data packets to another node in the LAN, without decrypting the data packets. The encrypted data packets are subsequently decrypted at a destination node in the LAN. Accordingly, wireless encryption operations are distributed in the LAN at least in that establishment of an encrypted wireless communication link and decryption of encrypted data packets may be performed at different nodes of the LAN.

As another example, in some embodiments, a thin WAP receives encrypted data packets from a first device, and the thin WAP forwards the encrypted data packets to an upstream node, without decrypting the data packets. The encrypted data packets are subsequently decrypted by a secure WAP that is different from the thin WAP.

Applicant has found that distributing wireless encryption and decryption operations at specific points in a network, instead of performing all wireless encryption operations at the point of first wireless transmission, may achieve significant advantages, as discussed below.

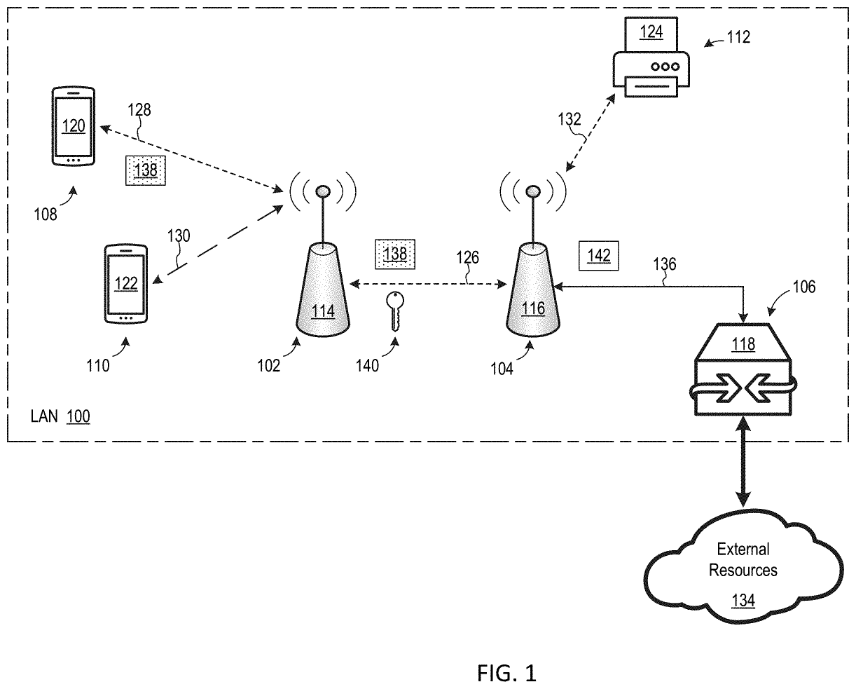

FIG. 1 is a block diagram of a LAN 100 supporting distributed wireless encryption. LAN 100 includes nodes 102, 104, 106, 108, 110, and 112. Node 102 includes a first WAP 114, node 104 includes a second WAP 116, node 106 includes a gateway device 118, node 108 includes a first device 120, node 110 includes a second device 122, and node 112 includes a third device 124. LAN 100 may include additional or fewer nodes without departing from the scope hereof. Additionally, any of the nodes of LAN 100 may include alternative and/or additional equipment. For example, in one alternate embodiment, second WAP 116 at node 104 is replaced with a network switch (not shown). As another example, in another alternate embodiment, node 106 includes a content server (not shown) along with gateway device 118. Furthermore, the topology of LAN 100 may vary. Moreover, LAN 100 could be modified to be a network other than a local area network, such as a wide area network, without departing from the scope hereof.

In some embodiments, each of first and second WAPs 114 and 116 is configured to operate according an IEEE 802.11 protocol and/or a fifth generation (5G), new radio (NR) protocol. However, first and second WAPs 114 and 116 could be configured to operate according to one or more other wireless communication protocols without departing from the scope hereof. First WAP 114 is illustrated as being communicatively coupled to second WAP 116 via a wireless communication link 126, e.g. as part of a mesh network of WAPs. In some alternate embodiments, though, wireless communication link 126 is replaced with, or by supplemented by, a wired communication link, such as a wired communication link including an electrical cable and/or an optical cable.

First WAP 114 and second WAP 116 are each configured to establish one or more wireless communication links with respective devices. These wireless communication links may be encrypted or unencrypted. In the embodiment of FIG. 1, first WAP 114 is illustrated as establishing (a) a first encrypted wireless communication link 128 with first device 120 and (b) a first unencrypted wireless communication link 130 with second device 122. Additionally, second WAP 116 is illustrated as establishing a second encrypted wireless communication link 132 with third device 124, in the FIG. 1 embodiment. However, the number and types of wireless communication links established by first and second WAPs 114 and 116 may vary. In some embodiments, first and second WAPs 114 and 116 are configured to establish encrypted wireless communication links, e.g. first and second encrypted wireless communication links 128 and 132, according to one of a WPA2 protocol and a WPA3 protocol. However, first and second WAPs 114 and 116 could be configured to establish encrypted wireless communication links according to one or more other protocols without departing from the scope hereof.

Gateway device 118 interfaces LAN 100 with external resources 134. In some embodiments, external resources 134 include one or more of the public Internet and one or more private networks. In some embodiments, gateway device 118 is configured to provide security services, e.g. to prevent unauthorized access to LAN 100 from external resources 134. Additionally, in some embodiments, gateway device 118 is configured to provide routing services, such as to route data packets from a client of LAN 100 to a specific destination in external resources 134, or vice versa. Furthermore, in some embodiments, gateway device 118 is configured to perform switching services, such as to route data packets within LAN 100. Gateway device 118 is communicatively coupled to second WAP 116 via a wired communication link 136 in the FIG. 1 embodiment. Wired communication link 136 includes, for example, an electrical cable and/or an optical cable. In some alternate embodiments, wired communication link 136 is replaced by, or supplemented with, a wireless communication link.

In the embodiment of FIG. 1, first and second devices 120 and 122 are each illustrated as being user equipment (UE), e.g. a mobile telephone, and second device 124 is illustrated as being a printer. However, each of first device 120, second device 122, and third device 124 could be replaced with another type of device without departing from the scope hereof. Examples of possible embodiments of first device 120, second device 122, and third device 124 include, but are not limited to, a computer, a set-top device, a data storage device, an IoT device, an entertainment device, another wireless access point (including, for example, eNBs, gNBs, and Wi-Fi APS acting as UEs), a computer networking device, a mobile telephone, a smartwatch, a wearable device with wireless capability, an output device (including, for example, a monitor, a printer, or a speaker), and a medical device.

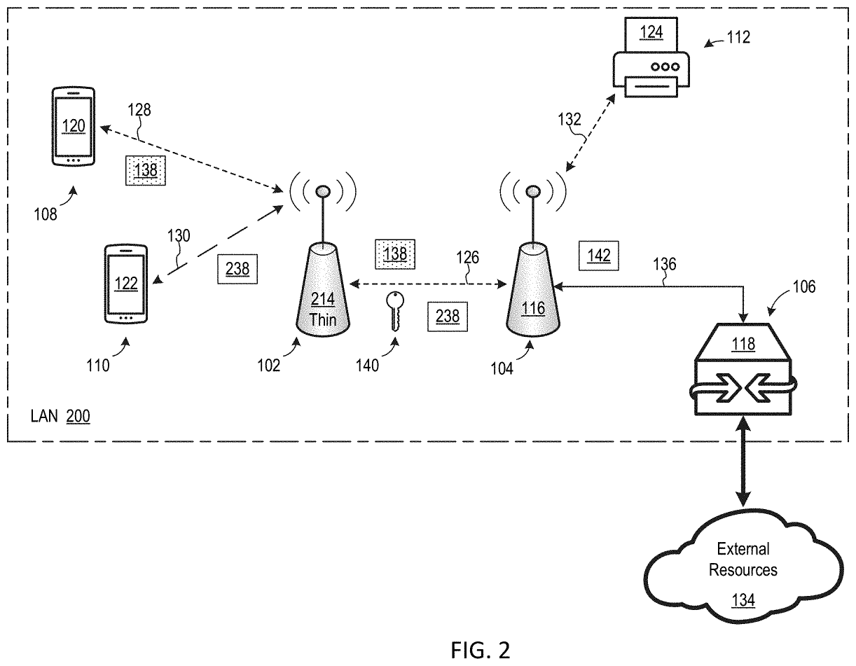

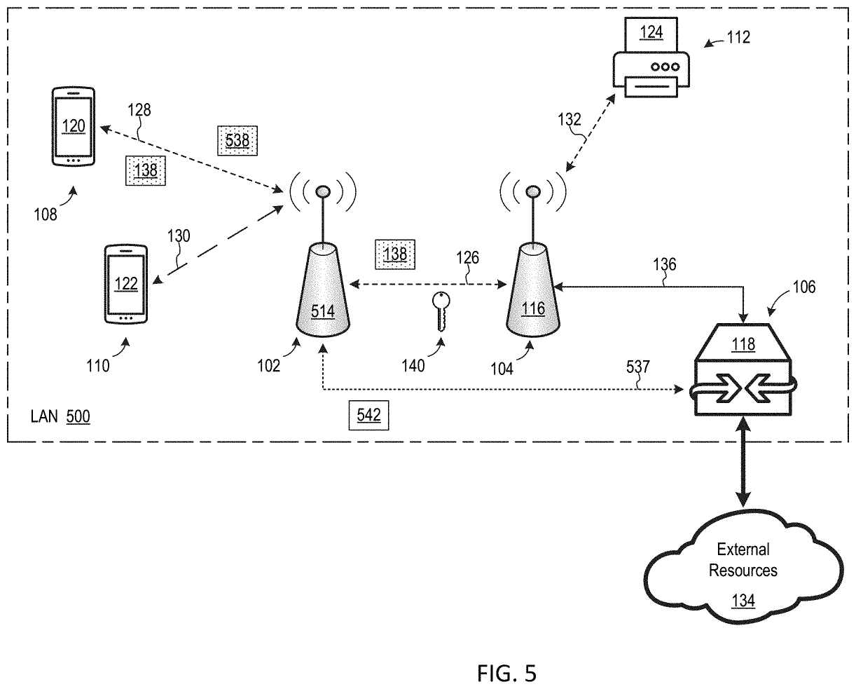

First WAP 114 is configured to (a) exchange encrypted data packets with first device 120 via first encrypted wireless communication link 128 and (b) exchange unencrypted data packets with second device 122 via first unencrypted wireless communication link 130. Second WAP 116 is configured to exchange encrypted data packets with third device 124 via second encrypted wireless communication link 132. In contrast to a conventional WAP, first WAP 114 is further configured to forward at least some encrypted data packets to an upstream node, e.g. node 104, without decrypting the encrypted data packets. For example, in one embodiment, first WAP 114 is configured to forward an encrypted data packet 138 received from first device 120 via first encrypted wireless communication link 128 to node 104, without decrypting data packet 138. In some embodiments, first WAP 114 is configured to forward all received data packets to an upstream node without performing encryption or decryption, such as discussed below with respect to FIG. 2. In some other embodiments, first WAP 114 is configured to selectively decrypt received data packets before forwarding them to the upstream node, such as discussed below with respect to FIGS. 5-8.

In some embodiments, first WAP 114 is also configured to forward to an upstream node, e.g. node 104, an encryption key used by first WAP 114 to establish an encrypted wireless communication link. For example, in an embodiment, first WAP 114 is configured to establish first encrypted wireless communication link 128 according to an encryption key 140, and encryption key 140 is therefore needed to decrypt encrypted data packet 138. First WAP 114 is configured to forward encryption key 140 to node 104, and second WAP 116 at node 104 is configured to decrypt encrypted data packet 138 using encryption key 140 to yield an unencrypted data packet 142. In some embodiments, second WAP 116 is further configured to forward decrypted data packet 142 to another node, e.g., node 106 or node 112.

The fact that encrypted data packet 138 travels from node 108 to node 104 without being decrypted may result in significant benefits. For example, first WAP 114 is relieved from decrypting encrypted data packet 138, which potentially reduces processing requirements and/or power consumption of the WAP. Furthermore, the fact that encrypted data packet 138 travels between WAPs 114 and 116 in encrypted form, instead of being decrypted by first WAP 114, promotes security by reducing likelihood of unauthorized access to data of encrypted data packet 138, while the data packet travels between the WAPs.

FIG. 2 is a block diagram of a LAN 200, which is an embodiment of LAN 100 where first WAP 114 is embodied by a thin WAP 214. In this document, a thin WAP is a WAP that is configured to wirelessly receive data packets and wirelessly retransmit the received data packets without performing encryption or decryption of the data packets. Accordingly, thin WAP 214 forwards encrypted data packets it receives without performing encryption or decryption of the data packets, such that the data packets remain encrypted as they flow through thin WAP 214. For example, thin WAP 214 wirelessly forwards encrypted data packet 138 received via first encrypted wireless communication link 128 to node 104 without decrypting the data packet. Additionally, thin WAP 214 forwards unencrypted data packets it receives without performing encryption or decryption of the data packets, such that the data packets remain unencrypted as they flow through thin WAP 214. For example, thin WAP 214 wirelessly forwards an unencrypted data packet 238 received from second device 122 via first unencrypted wireless communication link 130 to node 104, without encrypting the unencrypted data packet. It should be appreciated that thin WAP 214 may be lower cost, smaller, and/or simpler, than conventional WAPs, due to thin WAP 214 not needing to perform encryption operations.

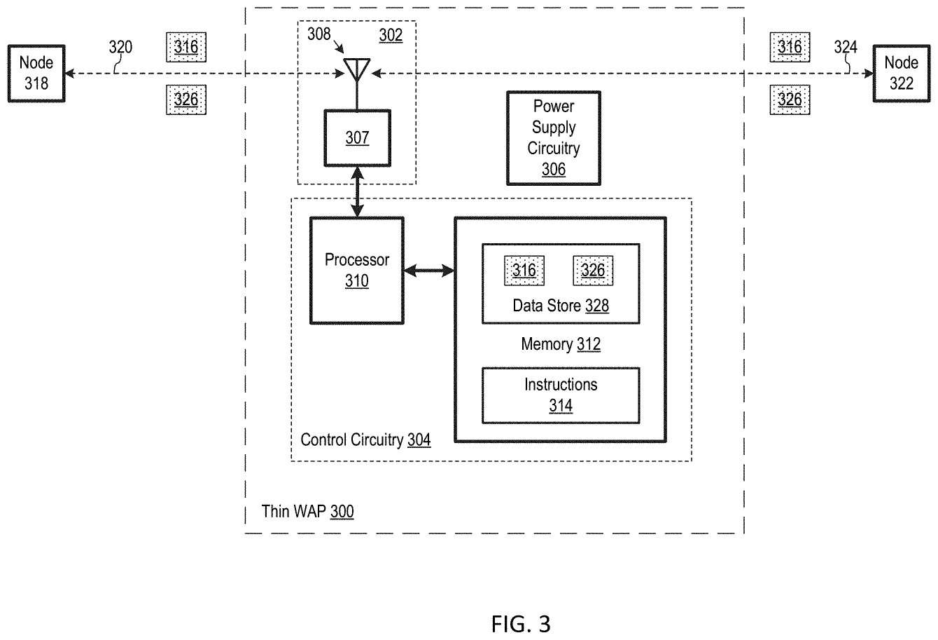

FIG. 3 is block diagram of a thin WAP 300, which is one possible embodiment of thin WAP 214. It should be realized, however, that thin WAP 214 may be embodied in other manners without departing from the scope hereof. Thin WAP 300 includes radio circuitry 302, control circuitry 304, and power supply circuitry 306. Power supply circuitry 306 is configured to provide electrical power to each of radio circuitry 302 and control circuitry 304. Radio circuitry 302 includes a transceiver 307 communicatively coupled to an antenna 308.

Control circuitry 304 includes a processor 310 communicatively coupled to a memory 312. Control circuitry 304 is configured to control radio circuitry 302. For example, in some embodiments, processor 310 is configured to execute instructions 314 stored in memory 312 to control radio circuitry 302 to (a) receive a first encrypted data packet 316 from a first node 318 via a first wireless communication link 320 between thin WAP 300 and first node 318, (b) forward first encrypted data packet 316 from thin WAP 300 to a second node 322 via a second wireless communication link 324 between thin WAP 300 and second node 322, without decrypting the first encrypted data packet, (c) receive a second encrypted data packet 326 from second node 322 via second wireless communication link 324, and (d) forward second encrypted data packet 326 from thin WAP 300 to first node 318 via first wireless communication link 320, without decrypting second encrypted data packet 326. Instructions 314 are, for example, software and/or firmware stored in memory 312. In some embodiments, transceiver 307 and antenna 308 collectively form a software defined radio that is controlled by control circuitry 304.

In some embodiments, processor 310 is further to configured to execute instructions 314 to store received data packets in a data store 328 of memory 312, before forwarding the data packets. For example, in some embodiments, processor 310 stores in data store 328 first encrypted data packet 316 received from a first node 318, before forwarding first encrypted data packet 316 to second node 322. Similarly, in some embodiments, processor 310 stores in data store 328 second encrypted data packet 326 received from second node 322, before forwarding second encrypted data packet 326 to first node 318. Storing received data packets in memory store 328 helps enable thin WAP 300 to function with a single transceiver 307.

In certain embodiments, one or both of nodes 318 and 322 includes a WAP, and in some embodiments, one or more of nodes 318 and 322 includes user equipment. In certain embodiments, control circuitry 304 is configured to control radio circuitry 302 to establish and maintain first and second wireless communication links 320 and 324 according to an IEEE 802.11 standard. First and second wireless communication links 320 and 324 are optionally encrypted. In some embodiments, first and second wireless communication links 320 and 324 operate on different respective wireless channels, e.g. on different respective Wi-Fi channels. In some other embodiments, first and second wireless communication links 320 and 324 operate on a common wireless channel, and thin WAP 300 is configured to remove signals transmitted on one of the first and second wireless communication links from signals received from the other of the first and second wireless communication links, to enable simultaneous data transmission on both of the first and second wireless communication links.

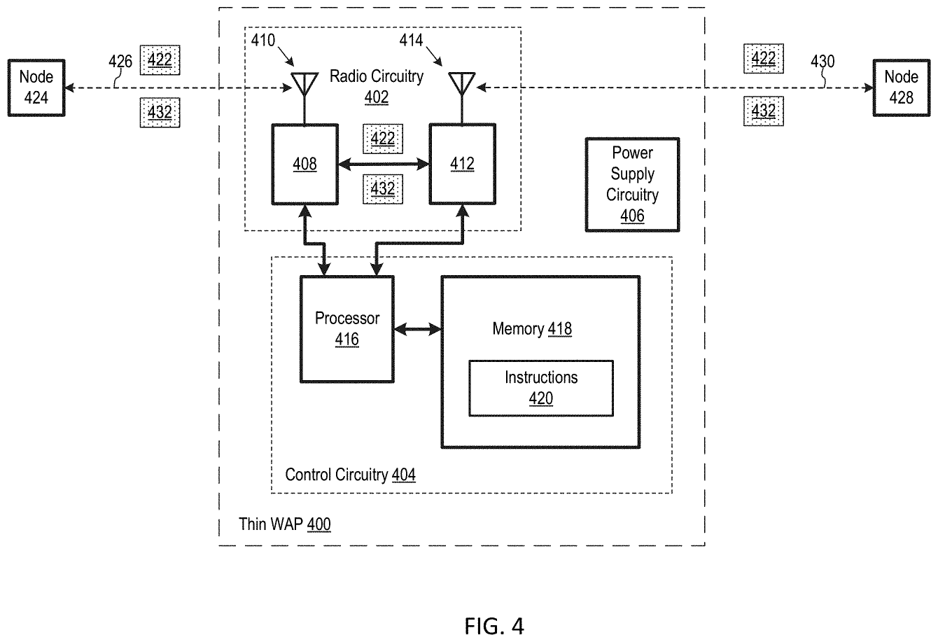

FIG. 4 is a block diagram of a thin WAP 400, which is another possible embodiment of thin WAP 214. Thin WAP 400 includes radio circuitry 402, control circuitry 404, and power supply circuitry 406. Power supply circuitry 406 is configured to provide electrical power to each of radio circuitry 402 and control circuitry 404. Radio circuitry 402 includes (a) a first transceiver 408 communicatively coupled to a first antenna 410 to form a first radio and (b) a second transceiver 412 communicatively coupled to a second antenna 414 to form a second radio. In some embodiments, first transceiver 408 and second transceiver 412 are configured to operate at different respective frequencies such that the two radios of radio circuitry 402 operate at different respective frequencies. In some other embodiments, first transceiver 408 and second transceiver 412 are configured to operate on different respective channels of a common radio frequency band. In yet other embodiments, first transceiver 408 and second transceiver 412 are configured to operate on different respective channels of different respective radio frequency bands.

Control circuitry 404 includes a processor 416 communicatively coupled to a memory 418. Control circuitry 404 is configured to control radio circuitry 402. For example, in some embodiments, processor 416 is configured to execute instructions 420 stored in memory 408 to control radio circuitry 402 to (a) receive a first encrypted data packet 422 from a first node 424 via a first wireless communication link 426 between thin WAP 400 and first node 424, (b) forward first encrypted data packet 422 from thin WAP 400 to a second node 428 via a second wireless communication link 430 between thin WAP 400 and second node 428, without decrypting the first encrypted data packet, (c) receive a second encrypted data packet 432 from second node 428 via second wireless communication link 430, and (d) forward second encrypted data packet 432 from thin WAP 400 to first node 424 via first wireless communication link 426, without decrypting second encrypted data packet 432. First transceiver 408 and first antenna 410 collectively establish first wireless communication link 426, and second transceiver 412 and second antenna 414 collectively establish second wireless communication link 430. In some embodiments, encrypted data packets 422 and 432 are transferred between first transceiver 408 and second transceiver 412, as illustrated in FIG. 4, such that it is unnecessary to buffer the encrypted data packets in memory 418. Instructions 420 are, for example, software and/or firmware stored in memory 418. In some embodiments, at least some of the elements of radio circuitry 402 form a software defined radio that is controlled by control circuitry 404.

In certain embodiments, one or both of nodes 424 and 428 includes a WAP, and in some embodiments, one or more of nodes 424 and 428 includes user equipment. In certain embodiments, control circuitry 404 is configured to control radio circuitry 402 to establish and maintain first and second wireless communication links 426 and 430 according to an IEEE 802.11 standard. First and second wireless communication links 426 and 430 are optionally encrypted.

FIG. 5 is a block diagram of a LAN 500, which is an embodiment of LAN 100 where first WAP 114 is embodied by a WAP 514 which is configured to selectively decrypt encrypted data packets before forwarding the data packets to an upstream node (e.g., node 104 or node 106). LAN 500 additionally includes a communication link 537 which directly links nodes 102 and 106. WAP 514 is configured to selectively decrypted an encrypted data packet that it receives, depending on whether the encrypted data packet is destined for a node within LAN 500 or for a node outside of LAN 500. Specifically, if the encrypted data packet is destined for a node within LAN 500, WAP 514 forwards the data packet to an upstream node without decrypting the data packet. Conversely, if the encrypted data is destined for a node outside of LAN 500, WAP 514 decrypts the data packet before forwarding the data packet to an upstream node.

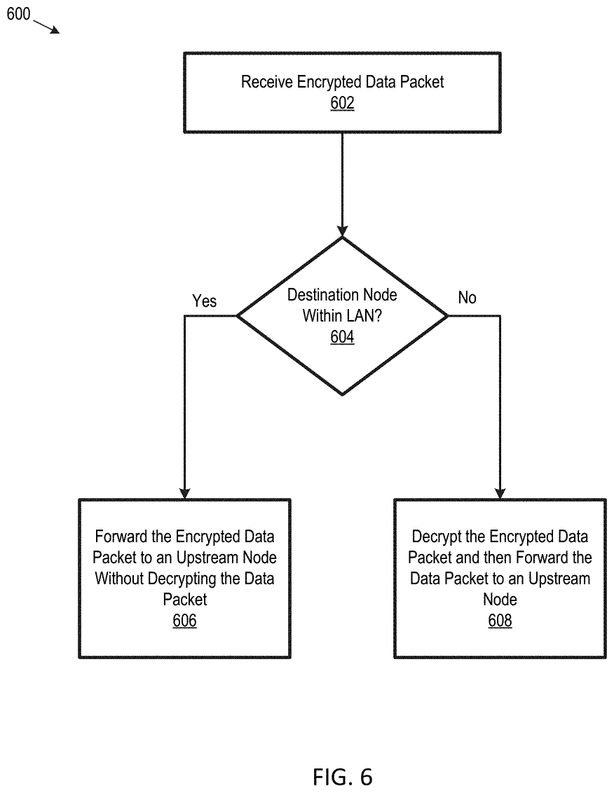

For example, in some embodiments, WAP 514 is configured to execute a method 600 illustrated in FIG. 6, for selectively decrypting data packets. In a block 602 of method 600, the WAP receives an encrypted data packet. In one example of block 602, WAP 514 receives encrypted data packet 138 via first encrypted wireless communication link 128, and in another example of block 602, WAP 514 receives an additional encrypted data packet 538 via first encrypted wireless communication link 128. In a decision block 604, the WAP determines whether the encrypted data packet received in block 602 is destined for a node within the LAN. In one example of decision block 604, WAP 514 determines that encrypted data packet 138 is destined for node 104 in LAN 200. In another example of decision block 604, WAP 514 determines that encrypted data packet 538 is destined for node outside of LAN 500 in external resources 134, e.g. via communication link 537 and gateway device 118. If the result of decision block 604 is yes, method 600 proceeds to a block 606 where the encrypted data packet is forwarded to an upstream node without decrypting the data packet. In one example of block 606, WAP 514 forwards encrypted data packet 138 to node 104 without decrypting the data packet. If the result of decision block 604 is no, method 600 proceeds to a block 608 where the encrypted data packet is decrypted and then forwarded to an upstream node. In one example of block 608, WAP 514 decrypts encrypted data packet 538 to generate an unencrypted data packet 542, and WAP 514 then forwards unencrypted data packet 542 from node 102 to node 106 via communication link 537, for transfer to its destination node in external resources 134. Some embodiments of WAP 514 are configured similarly to thin WAPs 300 and 400, but with respective instructions 314 and 420 replaced with instructions for performing method 600.

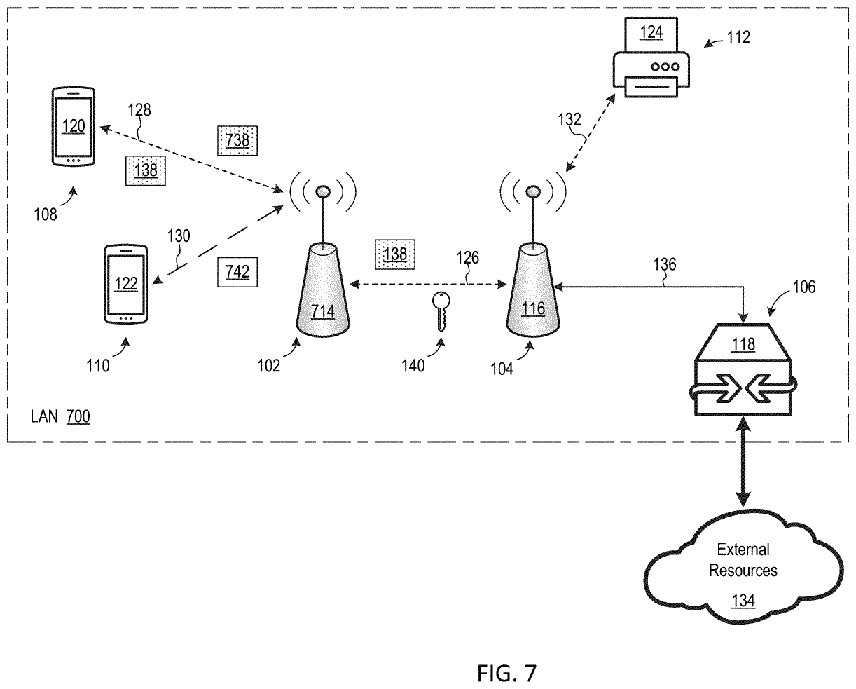

FIG. 7 is a block diagram of a LAN 700, which is an embodiment of LAN 100 where first WAP 114 is embodied by a WAP 714 which is configured to selectively decrypt encrypted data packets before forwarding the data packets to an upstream node (e.g., node 104). WAP 714 is configured to selectively decrypted an encrypted data packet that it receives, depending on whether the encrypted data packet is destined for a node that is capable of performing encryption. Specifically, if the encrypted data packet is destined for a node that is capable of performing decryption, WAP 714 forwards the data packet to an upstream node without decrypting the data packet. Conversely, if the encrypted data is destined for a node that is not capable of performing decryption, WAP 714 decrypts the data packet before forwarding the data packet to an upstream node.

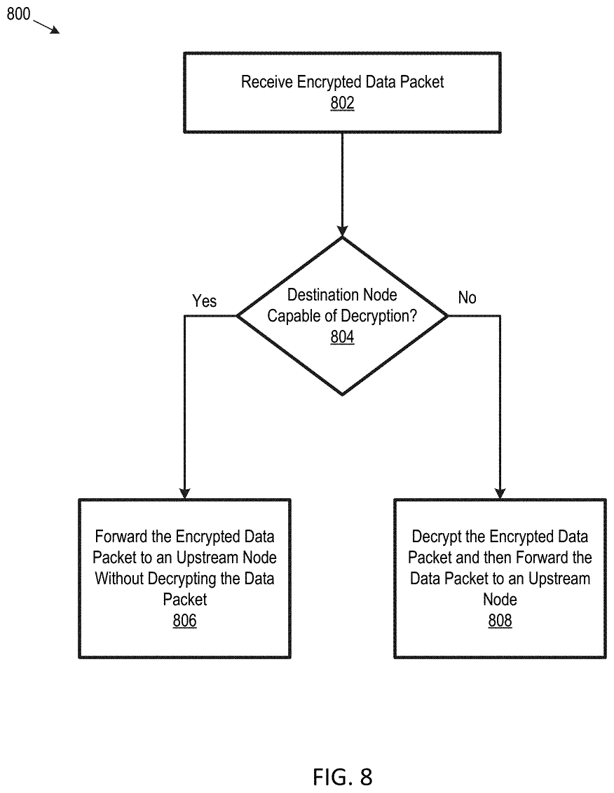

For example, in some embodiments, WAP 714 is configured to execute a method 800 illustrated in FIG. 8, for selectively decrypting data packets. In a block 802 of method 800, the WAP receives an encrypted data packet. In one example of block 802, WAP 714 receives encrypted data packet 138 via first encrypted wireless communication link 128, and in another example of block 802, WAP 714 receives an additional encrypted data packet 738 via first encrypted wireless communication link 128. In a decision block 804, the WAP determines whether the encrypted data packet received in block 802 is destined for a node that is capable of performing decryption. In one example of decision block 804, WAP 714 determines that encrypted data packet 138 is destined for node 104 which is capable of performing decryption. In another example of decision block 804, WAP 714 determines that encrypted data packet 738 is destined for node 110 which is not capable of performing decryption. If the result of decision block 804 is yes, method 800 proceeds to a block 806 where the encrypted data packet is forwarded to an upstream node without decrypting the data packet. In one example of block 806, WAP 714 forwards encrypted data packet 138 to node 104 without decrypting the data packet. If the result of decision block 804 is no, method 800 proceeds to a block 808 where the encrypted data packet is decrypted and then forwarded to an upstream node. In one example of block 808, WAP 714 decrypts encrypted data packet 738 to generate an unencrypted data packet 742, and WAP 714 then forwards unencrypted data packet 742 from node 102 to node 110. Some embodiments of WAP 714 are configured similarly to thin WAPs 300 and 400, but with respective instructions 314 and 420 replaced with instructions for performing method 800.

In an alternate embodiment of method 800, decision block 804 is modified to determine (a) whether the destination node is capable of decryption and (b) whether the destination node is within LAN 700. In this alternate embodiment, method 800 proceeds to block 806 if both conditions (a) and (b) are true, and method 800 proceeds to block 808 if either of conditions (a) and (b) is false.

In another alternate embodiment of method 800, decision block 804 is replaced with a first alternative decision block (not shown) which determines whether an operating status of WAP 714 meets a predetermined criterium. The predetermined criterium is, for example, that processing load of WAP 714 is below threshold value. If the result of the first alternative decision block is yes, method 800 proceeds to block 808, and if the result of the first alternative decision block is no, method 800 proceeds to block 806. Accordingly, in this alternative embodiment, WAP 714 decrypts received encrypted data packets if processing load of the WAP is below the threshold value, e.g. indicating that the WAP has sufficient processing capacity to perform decryption. On the other hand, if processing load of WAP 714 is above the threshold value, e.g. indicated that WAP 714 does not have significant extra capacity, WAP 714 forwards received encrypted data packets to an upstream node, without decrypting the data packets.

In another alternate embodiment of method 800, decision block 804 is replaced with a second alternative decision block (not shown) which determines whether LAN encryption is required. LAN encryption is required, for example, for security purposes, such as if LAN 700 is carrying sensitive data and/or if LAN 700 may be accessed by untrusted persons. If the result of the second alternative decision block is yes, method 800 proceeds to block 806, and if the result of the second alternative decision block is no, method 800 proceeds to block 808.

In another alternate embodiment of method 800, decision block 804 is replaced with a third alternative decision block (not shown) which determines whether a data packet received by WAP 714 is a low-latency data packet, i.e. whether the data packet must be transmitted by LAN with minimal latency. If the result of the third alternative decision block is yes, method 800 proceeds to block 806, to avoid latency associated with decryption. On the flip side, if the result of the third alternative decision block is no, method 800 proceeds to block 808 to decrypt the data packet.

Decision block 804 could be replaced with other alternative decision blocks without departing from the scope hereof.

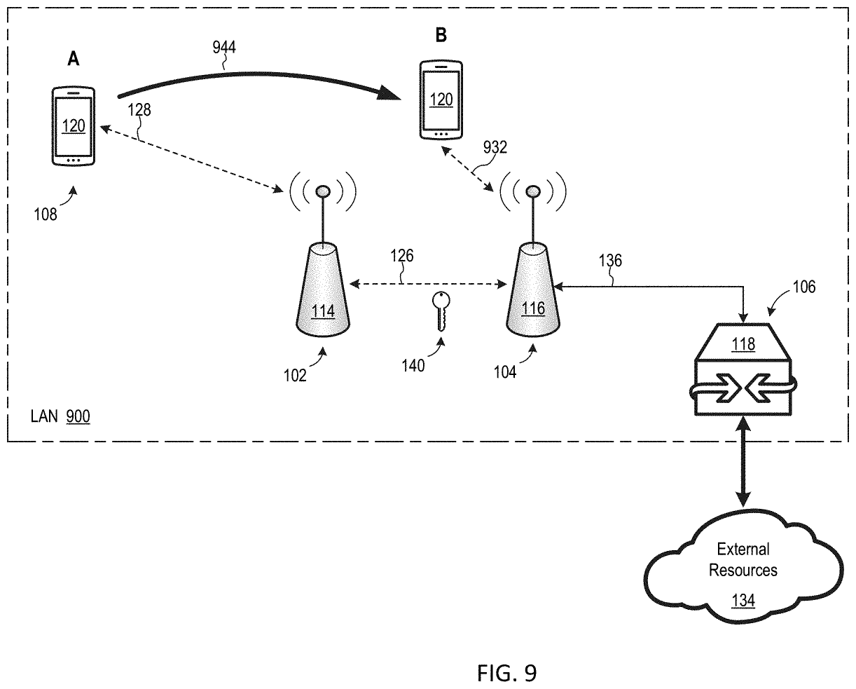

Some embodiments of LANs 100, 200, 500, and 700 are further configured to support roaming of a device among WAPs by transmitting an encryption key among WAPs, thereby promoting fast transitioning of the device from one WAP to another WAP. For example, FIG. 9 is a block diagram of a LAN 900, which is an embodiment of LAN 100 configured to transmit an encryption key among WAPs for roaming purposes. In the FIG. 9 embodiment, first device 120 is initially located at position A in LAN 900, and first WAP 114 establishes first encrypted wireless communication link 128 according to encryption key 140. First device 120 subsequently moves (roams) to position B in LAN 900, as represented by an arrow 944, where position B is closer to second WAP 116 than to first WAP 114. First WAP 114 and second WAP 116 accordingly cooperate to transfer encryption key 140 from first WAP 114 to second WAP 116, and second WAP 116 subsequently establishes a second encrypted wireless communication link 932 with first device 120 according to encryption key 140. First WAP 114 and second WAP 116 optionally additionally cooperate to transfer a current state of first device 120 from first WAP 114 to second WAP 116 to assist in transitioning first device 120 from first WAP 114 to second WAP 116. Second WAP 116 exchanges data packets with first device 120 via second encrypted wireless communication link 932. The fact that first and second encrypted wireless communication links 128 and 932 use a common encryption key, i.e. encryption key 140, supports fast transitioning of first device 120 from first WAP 114 to second WAP 116.

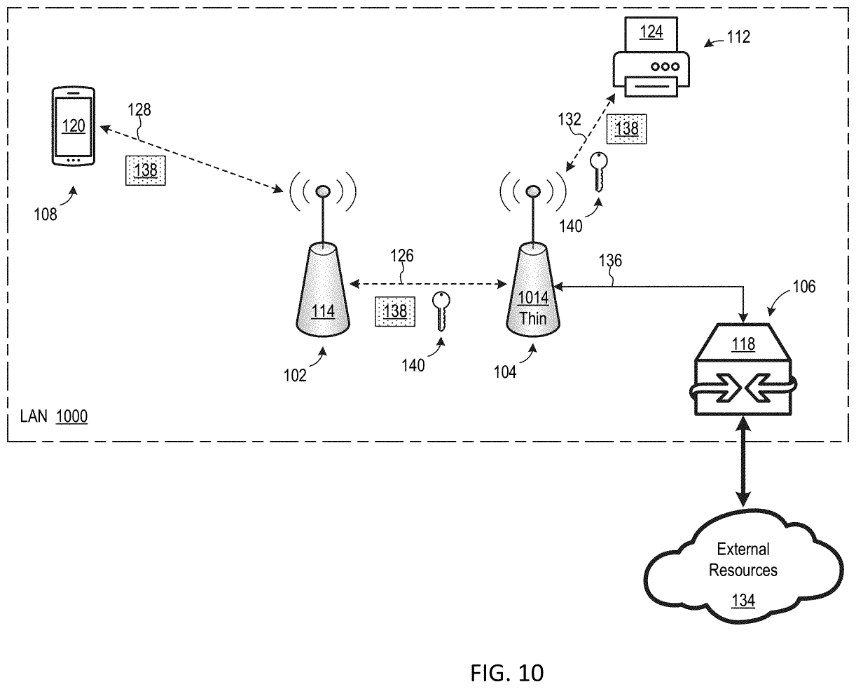

Discussed below with respect to FIGS. 10-15 are several alternate embodiments of LAN 100. It should be appreciated, however, that LAN 100 could have other alternate configurations without departing from the scope hereof.

FIG. 10 is a block diagram of a LAN 1000, which is an alternate embodiment of LAN 100 where second WAP 116 is replaced with a thin WAP 1014. In some embodiments, thin WAP 1014 is embodied similar to thin WAP 300 or thin WAP 400 of FIGS. 3 and 4, respectively. In some embodiments, first WAP 114 is embodied as one of thin WAP 214, WAP 514, or WAP 714. Thin WAP 1014 forwards encrypted data packet 138 received from node 102 to node 112, without decrypting the data packet. Additionally, thin WAP 1014 optionally forwards encryption key 140 received from node 102 to node 112. Third device 124 at node 112 subsequently decrypts data packet 138 using encryption key 140. Accordingly, encrypted data packet 138 travels from node 108 to node 112 without being decrypted, thereby promoting low latency of data packet 138, low processing requirements of WAPs 114 and 1014, low power consumption of WAPs 114 and 1014, and security of data in encrypted data packet 138.

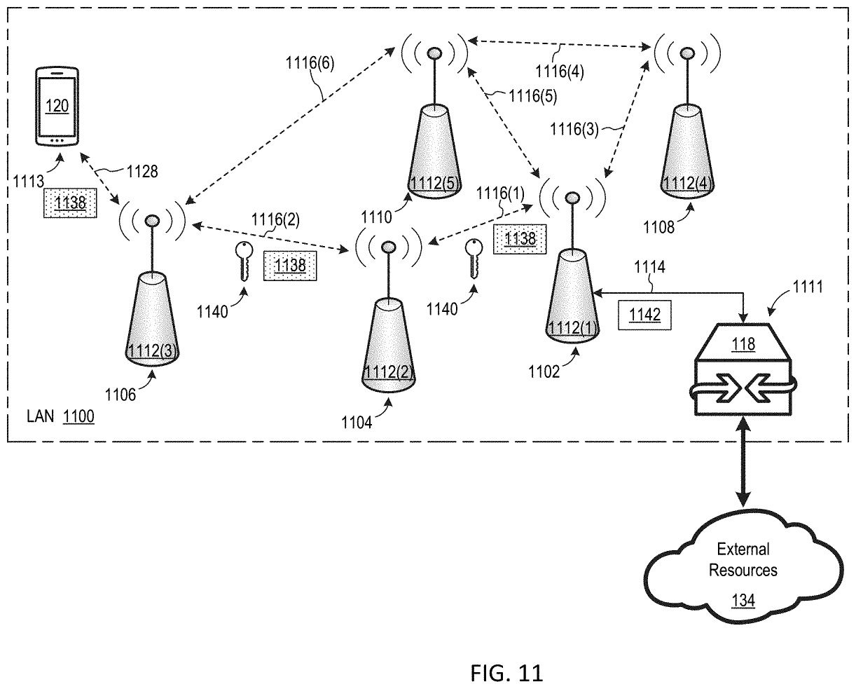

FIG. 11 is block diagram of a LAN 1100, which is an alternate embodiment of LAN 100 supporting distributed wireless encryption among a plurality of WAPs configured as a mesh network. LAN includes nodes 1102, 1104, 1106, 1108, 1111, and 1113. Each of nodes 1102, 1104, 1106, 1108, and 1110 includes a respective WAP 1112, node 1111 includes an instance of gateway device 118, and node 1113 includes an instance of first device 120. In this document, specific instances of an item may be referred to by use of a numeral in parentheses (e.g., WAP 1112(1)) while numerals without parentheses refer to any such item (e.g., WAPs 1112). LAN 1100 may include additional nodes without departing from the scope hereof.

In some embodiments, each WAP 1112 is embodied as first WAP 114, second WAP 116, thin WAP 214, WAP 514, or WAP 714. Each WAP 1112, however, need not have the same configuration. For example, in one embodiment, WAP 1112(3) is embodied as WAP 514 or 714, WAP 1112(1) is embodied as second WAP 116, and each other WAP 1112 is embodied as thin WAP 214. WAP 1112(1) is communicatively coupled to gateway device 118 via a communication link 1114, which includes, for example, one or more of an electrical cable, an optical cable, and a wireless communication link. WAPs 1112(2)-1112(5) are communicatively coupled to WAP 1112(1) via wireless communication links 1116, so that WAPs 1112 collectively form a wireless mesh network. Wireless communication links 1116 are optionally encrypted. WAP 1112(3) is configured to establish an encrypted wireless communication link 1128 with first device 120 according to an encryption key 1140, and WAP 1112(3) exchanges data packets with first device 120 via encrypted wireless communication link 1128. In some embodiments, WAP 1112(3) is configured to establish encrypted wireless communication link 1128 according to one of a WPA2 protocol and a WPA3 protocol. However, WAP 1112(3) could be configured to establish encrypted wireless communication link 1128 according to one or more other protocols without departing from the scope hereof.

In an embodiment, WAP 1112(3) receives an encrypted data packet 1138 from first device 120 via encrypted wireless communication link 1128. WAP 1112(3) forwards encrypted data packet 1138 to node 1104 without decrypting the data packet. WAP 1112(2) at node 1104 forwards encrypted data packet 1138 to node 1102 without decrypting the data packet, such that decrypted data packet 1138 arrives at its destination node (node 1102) without being decrypted. WAP 1112(3) also optionally forwards encryption key 1140 to node 1104, and WAP 1112(2) at node 1104 optionally forwards encryption key 1140 to node 1102. WAP 1112(1) at node 1102 decrypts encrypted data packet 1138 using encryption key 1140, to yield decrypted data packet 1142. WAP 1112(1) optionally forwards decrypted data packet 1142 to gateway device 118 via communication link 1114, as illustrated in FIG. 11.

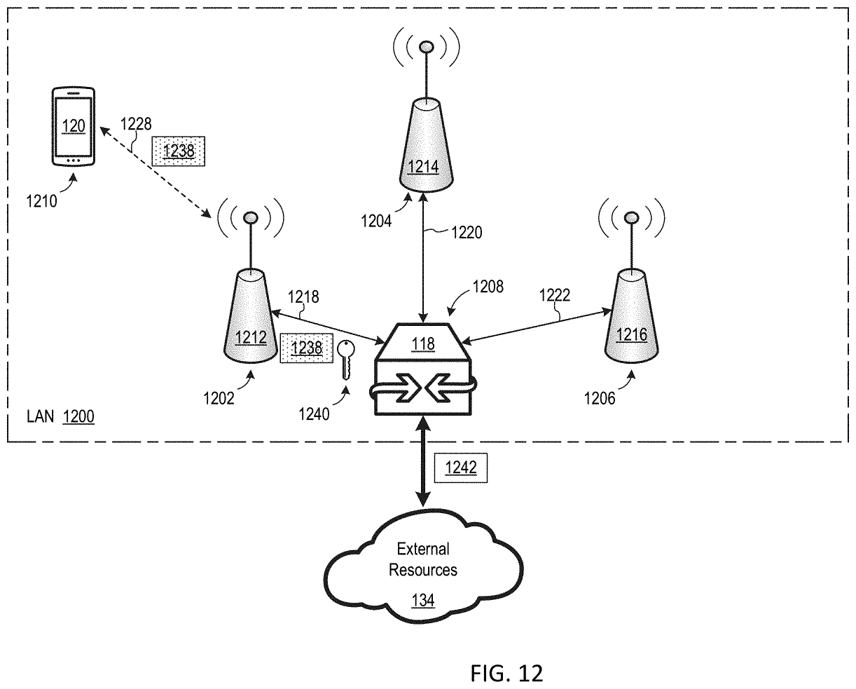

FIG. 12 is a block diagram of a LAN 1200, which is an alternate embodiment of LAN 100 including a plurality of WAPs communicatively coupled to a gateway device in a star configuration. LAN 1200 includes nodes 1202, 1204, 1206, 1208, and 1210. Nodes 1202, 1204, and 1206 include WAPs 1212, 1214, and 1216, respectively. Node 1208 includes an instance of gateway device 118, and node 1210 includes an instance of first device 120. LAN 1200 could be modified to have a different number of nodes without departing from the scope hereof.

In some embodiments, each of WAP 1212, 1214, and 1216 is embodied as first WAP 114, second WAP 116, thin WAP 214, WAP 514, or WAP 714. Each WAP of LAN 1200, however, need not have the same configuration. Each of communication links 1218, 1220, and 1222 includes, for example, one or more of an electrical cable, an optical cable, and a wireless communication link. WAP 1212 is configured to establish an encrypted wireless communication link 1228 with first device 120 according to an encryption key 1240, and WAP 1212 exchanges data packets with first device 120 via encrypted wireless communication link 1228. In some embodiments, WAP 1214 is configured to establish encrypted wireless communication link 1228 according to one of a WPA2 protocol and a WPA3 protocol. However, WAP 1212 could be configured to establish encrypted wireless communication link 1218 according to one or more other protocols without departing from the scope hereof.

In an embodiment, WAP 1212 receives an encrypted data packet 1238 from first device 120 via encrypted wireless communication link 1228. WAP 1212 forwards encrypted data packet 1238 to node 1208 without decrypting the data packet. WAP 1212 also optionally forwards encryption key 1240 to node 1208. Gateway device 118 at node 1208 decrypts encrypted data packet 1238 using encryption key 1240, to yield decrypted data packet 1242. Decrypted data packet 1242 is optionally forwarded to external resources 134, as illustrated in FIG. 12.

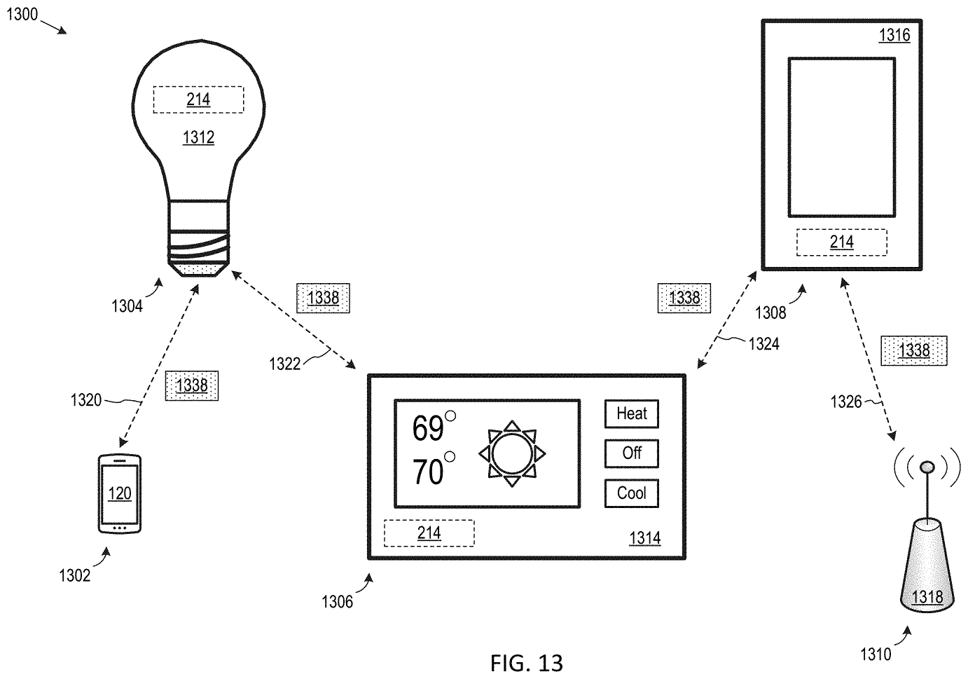

The fact that a thin WAP is configured to forward encrypted data packets without decrypting the data packets helps minimize processing and power requirements of the thin WAP, as well as cost of the thin WAP, thereby facilitating incorporation of the thin WAP into another device, such as an IoT device. For example, FIG. 13 is a block diagram of an alternate embodiment of LAN 100 including a plurality of IoT devices, where each IoT device includes an instance of thin WAP 214. LAN 1300 includes nodes 1302, 1304, 1306, 1308, and 1310. Node 1302 includes an instance of first device 120, node 1304 includes a light bulb 1312, node 1306 includes a thermostat 1314, node 1308 includes a light switch 1316, and node 1310 includes a WAP 1318. Each of light bulb 1312, thermostat 1314, and light switch 1316 is an IoT device, i.e. each of these devices is capable of communicating via the Internet. Additionally, each of light bulb 1312, thermostat 1314, and light switch 1316 includes an instance of thin WAP 214, symbolically shown in FIG. 13 by boxes formed of dashed lines. Accordingly, light bulb 1312, thermostat 1314, and light switch 1316 collectively form a mesh wireless network, and each of light bulb 1312, thermostat 1314, and light switch 1316 can relay encrypted data packets without decrypting the data packets.

For example, FIG. 13 illustrates first device 120 generating an encrypted data packet 1338, which is transmitted to WAP 1318 via the IoT devices of LAN 1300. Specifically, light bulb 1312 receives encrypted data packet 1338 via an encrypted wireless communication link 1320. Light bulb 1312 forwards encrypted data packet 1338 to thermostat 1314 via an encrypted wireless communication link 1322, without decrypting encrypted data packet 1338. Thermostat 1314 forwards encrypted data packet 1338 to light switch 1316 via an encrypted wireless communication link 1324, without decrypting encrypted data packet 1338, and light switch 1316 forwards encrypted data packet 1338 to WAP 1318 via an encrypted wireless communication link 1326, without decrypting encrypted data packet 1338. WAP 1318 optionally decrypts encrypted data packet 1338. It should be noted that transmission of data packet 1338 in LAN 1300 without decrypting the data packet relieves the IoT devices from performing decryption, thereby promoting simplicity of the IoT devices and low power consumption by the IoT devices. Additionally, transmission of data packet 1338 in LAN 1300 in encrypted form promotes security by reducing likelihood of unauthorized access to data of the data packet as the data packet travel in LAN 1300.

LAN 1300 could have fewer nodes or additional nodes without departing from the scope hereof. Additionally, the IoT devices at the nodes of LAN 1300 could vary. For example, in an alternate embodiment, thermostat 1314 and light switch 1316 are each replaced with a respective instance of light bulb 1312, such that a plurality of IoT light bulbs form a mesh wireless network in LAN 1300. Furthermore, in some alternate embodiments, one or more of wireless communication links 1320, 1322, 1324, and 1326 are not encrypted.

Applicant has determined that incorporating thin WAPs into IoT devices may achieve significant advantages. For example, conventional WAPs are considered by many to be unsightly. Incorporating thin WAPs into IoT devices, however, enables the WAPs to be partially or completely hidden, e.g. hidden within an IoT lightbulb, thermostat, or light switch, thereby promoting pleasing aesthetics. As another example, IoT devices are often found at locations that would ideal for a WAP, such as in a light fixture that is in line-of-sight to most of a room. Therefore, incorporating thin WAPs into IoT devices may promote good wireless communication coverage and performance. As yet another example, conventional WAPs require an electrical power source which may limit their deployment, e.g. a conventional WAP may need to be within close proximity to an electrical outlet. A thin WAP incorporated into an IoT device, however, may operate from the IoT device's power source, thereby enabling the thin WAP to be used in locations lacking a nearby electrical outlet.

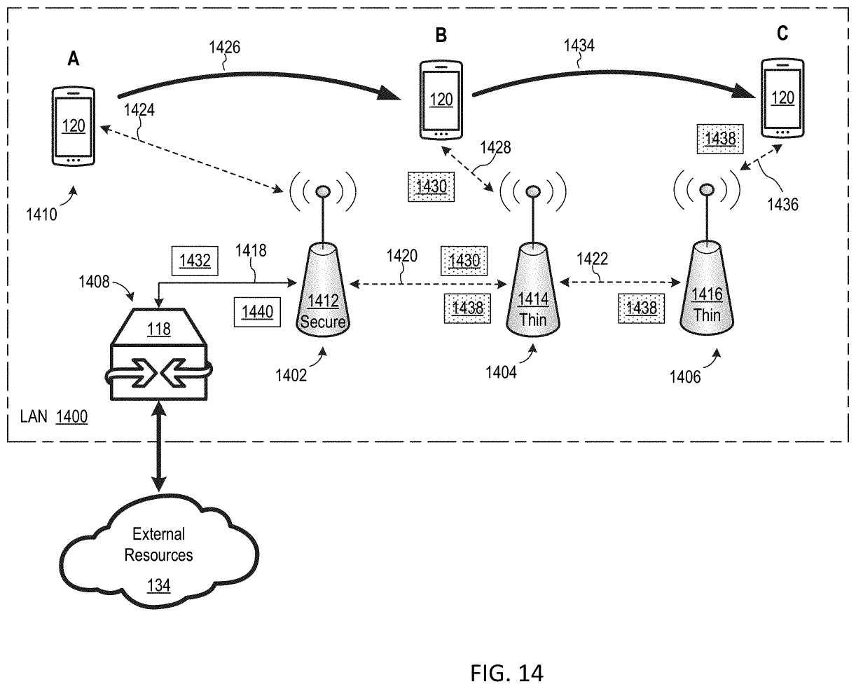

FIG. 14 is a block diagram of a LAN 1400, which is an alternate embodiment of LAN 100 including a secure WAP and a plurality of thin WAPs. LAN 1400 includes nodes 1402, 1404, 1406, 1408, and 1410. Nodes 1402, 1404, and 1406 include a secure WAP 1412, a thin WAP 1414, and a thin WAP 1416, respectively. Node 1408 includes an instance of gateway device 118, and node 1410 includes an instance of first device 120. LAN 1400 could be modified to have a different number of nodes without departing from the scope hereof.

Secure WAP 1412 is communicatively coupled to gateway device 118 via a communication link 1418 which includes, for example, one or more of an electrical cable, wired network cable, an optical cable, and a wireless communication link. Thin WAP 1414 is illustrated as being communicatively coupled to secure WAP 1412 via a wireless communication link 1420, and thin WAP 1416 is illustrated as being communicatively coupled to thin WAP 1414 via a wireless communication link 1422. In embodiments, wireless communication links 1420 and 1422 operate at different respective frequencies. In some other embodiments, wireless communication links 1420 and 1422 operate on different respective channels of a common or different radio frequency band. In yet other embodiments, wireless communication links 1420 and 1422 operate on a common channel, and thin WAP 1414 is configured to remove signals transmitted on one of wireless communication links 1420 and 1422 from signals received from the other of wireless communication links 1420 and 1422, to enable simultaneous data transmission on wireless communication links 1420 and 1422. In some alternate embodiments, wireless communication links 1420 and/or 1422 are replaced with, or by supplemented by, a wired communication link, such as a wired communication link including an electrical cable and/or an optical cable. Additionally, in some alternate embodiments, thin WAP 1416 is directly communicatively coupled to thin WAP 1414.

In some embodiments, each of secure WAP 1412, thin WAP 1414, and thin WAP 1416 is configured to operate according an IEEE 802.11 protocol and/or a 5G, NR protocol. However, the WAPs could be configured to operate according to one or more other wireless communication protocols without departing from the scope hereof. In some embodiments, each of thin WAP 1414 and thin WAP 1416 is embodied similar to thin WAP 300 or thin WAP 400 of FIGS. 3 and 4, respectively.

Secure WAP 1412 is configured to establish an encrypted wireless communication link 1424 with first device 120, and secure WAP 1412 exchanges encrypted data packets with first device 120 via encrypted wireless communication link 1424. In some embodiments, secure WAP 1214 is configured to establish encrypted wireless communication link 1424 according to one of a WPA2 protocol and a WPA3 protocol. However, secure WAP 1412 could be configured to establish encrypted wireless communication link 1424 according to one or more other protocols without departing from the scope hereof. In contrast to a conventional WAP, secure WAP 1412 is further configured decrypt data packets received from another WAP, such as a thin WAP.

For example, FIG. 14 illustrates first device 120 being initially located at position A in LAN 1400, and secure WAP 1412 establishes encrypted wireless communication link 1424, as discussed above. First device 120 subsequently moves (roams) to position B in LAN 1400, as represented by an arrow 1426, where position B is closer to thin WAP 1414 than to secure WAP 1412. Thin WAP 1414 accordingly establishes an encrypted wireless communication link 1428 with first device 120 at position B, and thin WAP 1414 exchanges encrypted data packets 1430 with first device 120 via encrypted wireless communication link 1428. Secure WAP 1412 and thin WAP 1414 optionally additionally cooperate to transfer a current state of first device 120 from secure WAP 1412 to thin WAP 1414, to assist in transitioning first device 120 from secure WAP 1412 to thin WAP 1414. Thin WAP 1414 does not have decryption capability, and thin WAP 1414 therefore forwards encrypted data packets 1430 to secure WAP 1412 for decryption. Secure WAP 1412 decrypts encrypted data packets 1430 to yield decrypted data packets 1432. In some embodiments, secure WAP 1412 forwards decrypted data packets 1440 to gateway device 118.

First device 120 next moves (roams) from position B to position C in LAN 1400, as represented by an arrow 1434, where position C is closer to thin WAP 1416 than to thin WAP 1414. Thin WAP 1416 accordingly establishes an encrypted wireless communication link 1436 with first device 120 at position C, and thin WAP 1416 exchanges encrypted data packets 1438 with first device 120 via encrypted wireless communication link 1436. Thin WAP 1414 and thin WAP 1416 optionally additionally cooperate to transfer a current state of first device 120 from thin WAP 1414 to thin WAP 1416, to assist in transitioning first device 120 from thin WAP 1414 to thin WAP 1416. Thin WAP 1416 does not have decryption capability, and thin WAP 1416 therefore forwards encrypted data packets 1438 to secure WAP 1412 for decryption. Secure WAP 1412 decrypts encrypted data packets 1438 to yield decrypted data packets 1440. In some embodiments, secure WAP 1412 forwards decrypted data packets 1440 to gateway device 1418.

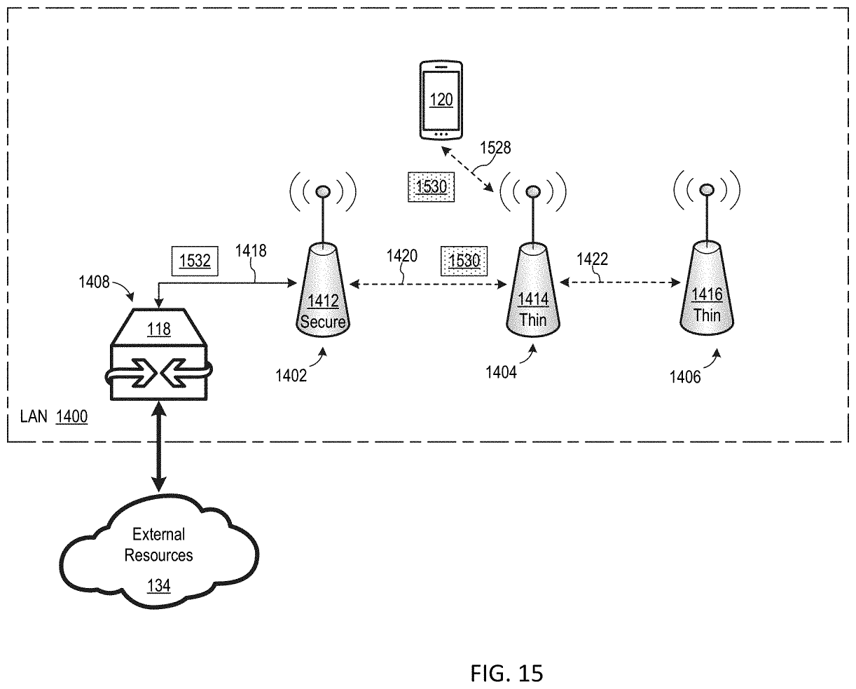

In FIG. 14, first device 120 initially connects to secure WAP 1412 to initiate an encrypted communication session with LAN 1400 (via encrypted wireless communication link 1424). In some embodiments of LAN 1400, thin WAPs 1414 and 1416 are also configured to initiate an encrypted communication session with a device, such as first device 120. For example, FIG. 15 is a block diagram illustrating an alternative operating scenario of LAN 1400 where thin WAP 1414, instead of secure WAP 1412, initiates an encrypted communication session with first device 120. Specifically, thin WAP 1414 establishes an encrypted wireless communication link 1528 with first device 120, and thin WAP 1414 exchanges encrypted data packets 1530 with first device 120 via encrypted wireless communication link 1528. In some embodiments, thin WAP 1414 handles encryption key negotiation with first device 120 to establish encrypted wireless communication link 1528. In some other embodiments, thin WAP 1414 acts as a conduit between first device 120 and secure WAP 1412 for encryption key negotiation data, such that secure WAP 1412 handles key negotiation with first device 120 to establish encrypted wireless communication link 1528. Thin WAP 1414 forwards encrypted data packets 1530 to secure WAP 1412 for decryption. Secure WAP 1412 decrypts encrypted data packets 1530 to yield decrypted data packets 1532. In some embodiments, secure WAP 1412 forwards decrypted data packets 1532 to gateway device 1418.

Features described above may be combined in various ways without departing from the scope hereof. The following examples illustrate some possible combinations:

(A1) A method for distributed wireless encryption may include (1) establishing, at a first WAP, a first encrypted wireless communication link between the first WAP and a first device, (2) receiving, at the first WAP, a first encrypted data packet from the first device via the first encrypted wireless communication link, and (3) forwarding the first encrypted data packet from the first WAP to a first node within a first LAN including the first WAP, without decrypting the first encrypted data packet.

(A2) In the method denoted as (A1), establishing the first encrypted wireless communication link may include establishing the first encrypted wireless communication link according to an encryption key, and the method may further include forwarding the encryption key from the first WAP to the first node.

(A3) Any one of the methods denoted as (A1) and (A2) may further include decrypting the first encrypted data packet at a second WAP that is different from the first WAP.

(A4) Any one of the methods denoted as (A1) and (A2) may further include decrypting the first encrypted data packet at a gateway device of the first LAN.

(A5) Any one of the methods denoted as (A1) through (A4) may further include forwarding the first encrypted data packet from the first node to a second node within the first LAN, without decrypting the encrypted data packet.

(A6) In the method denoted as (A5), forwarding the first encrypted data packet from the first node to the second node may include forwarding the first encrypted data packet via a wireless communication link between the first node and the second node.

(A7) In the method denoted as (A1), establishing the first encrypted wireless communication link may include establishing the first encrypted wireless communication link according to an encryption key, and the method may further include (1) forwarding the encryption key from the first WAP to a second WAP and (2) establishing a second encrypted wireless communication link between the first device and the second WAP, using the encryption key forwarded from the first WAP to the second WAP.

(A8) The method denoted as (A1) may further include (1) receiving, at the first WAP, a second encrypted data packet from the first device via the first encrypted wireless communication link, and (2) decrypting, at the first WAP, the second encrypted data packet.

(A9) The method denoted as (A1) may further include (1) determining, at the first WAP, that the first encrypted data packet is destined for a destination node within the first LAN, and (2) in response to determining that the first encrypted data packet is destined for the destination node within the first LAN, performing the step of forwarding the first encrypted data packet from the first WAP to the first node within the first LAN, without decrypting the first encrypted data packet.

(A10) The method denoted as (A1) may further include (1) receiving, at the first WAP, a second encrypted data packet, (2) determining, at the first WAP, that the second encrypted data packet is destined for a destination node outside of the first LAN, and (3) in response to determining that the second encrypted data packet is destined for a destination node outside of the first LAN, decrypting the second encrypted data packet at the first WAP.

(A11) The method denoted as (A1) may further include (1) receiving, at the first WAP, a second encrypted data packet, (2) determining, at the first WAP, that the second encrypted data packet is destined for a destination node that does not have decryption capability, and (3) in response to determining that the second encrypted data packet is destined for a destination node that does not have decryption capability, decrypting the second encrypted data packet at the first WAP.

(A12) The method denoted as (A1) may further include (1) receiving, at the first WAP, a second encrypted data packet, (2) determining that an operating status of the first WAP meets a predetermined criterium, and (3) in response to determining that the operating status of the first WAP meets the predetermined criterium, decrypting the second encrypted data packet at the first WAP.

(A13) The method denoted as (A1) may further include (1) determining, at the first WAP, that the first encrypted data packet is a low-latency data packet, and (2) in response to determining that the first encrypted data packet is the low-latency data packet, performing the step of forwarding the first encrypted data packet from the first WAP to the first node within the first LAN, without decrypting the first encrypted data packet.

(A14) The method denoted as (A1) may further include (1) establishing, at the first WAP, a first unencrypted wireless communication link between the first WAP and a second device, (2) receiving, at the first WAP, a first unencrypted data packet from the second device via the first unencrypted wireless communication link, and (3) forwarding the first unencrypted data packet from the first WAP to the first node without encrypting the first unencrypted data packet.

(A15) In any one of the methods denoted as (A1) through (A14), the first WAP may include a WAP operating according to an IEEE 802.11 standard.

(A16) In any one of the methods denoted as (A1) through (A15), establishing the first encrypted wireless communication link may include establishing the first encrypted wireless communication link according to one of a WPA2 protocol and a WPA3 protocol.

(B1) A thin WAP may include radio circuitry, control circuitry, and power supply circuitry configured to provide electrical power to each of the radio transceiver circuitry and the control circuitry. The control circuitry may be configured to control the radio circuitry to (1) receive a first encrypted data packet from a first node via a first wireless communication link between the thin WAP and the first node, (2) forward the first encrypted data packet from the thin WAP to a second node via a second wireless communication link between the thin WAP and the second node, without decrypting the first encrypted data packet, (3) receive a second encrypted data packet from the second node via the second wireless communication link, and (4) forward the second encrypted data packet from the thin WAP to the first node via the first wireless communication link, without decrypting the second encrypted data packet.

(B2) In the thin WAP denoted as (B1), the radio circuitry and the control circuitry may be configured to collectively maintain each of the first wireless communication link and the second wireless communication link at the thin WAP according to an IEEE 802.11 standard.

(B3) In any one of the thin WAPs denoted as (B1) and (B2), the control circuitry may be further configured to control the radio circuitry to operate the first and second wireless communication links on different respective wireless channels.

(B4) In any one of the thin WAPs denoted as (B1) and (B2), the control circuitry may be further configured to control the radio circuitry to operate the first and second wireless communication links at different respective radio frequencies.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present networks, devices, and methods, which, as a matter of language, might be said to fall therebetween.

What is claimed is:

1. A method for distributed wireless encryption, comprising:
establishing, at a first wireless access point (WAP), a first encrypted wireless communication link between the first WAP and a first device;
receiving, at the first WAP, a first encrypted data packet from the first device via the first encrypted wireless communication link; and
forwarding the first encrypted data packet from the first WAP to a first node within a first local area network (LAN) including the first WAP, without decrypting the first encrypted data packet.

2. The method of claim 1, wherein establishing the first encrypted wireless communication link comprises establishing the first encrypted wireless communication link according to an encryption key, and the method further comprises forwarding the encryption key from the first WAP to the first node.

3. The method of claim 1, further comprising decrypting the first encrypted data packet at a second WAP that is different from the first WAP.

4. The method of claim 1, further comprising decrypting the first encrypted data packet at a gateway device of the first LAN.

5. The method of claim 1, further comprising forwarding the first encrypted data packet from the first node to a second node within the first LAN, without decrypting the encrypted data packet.

6. The method of claim 5, wherein forwarding the first encrypted data packet from the first node to the second node comprises forwarding the first encrypted data packet via a wireless communication link between the first node and the second node.

7. The method of claim 1, wherein establishing the first encrypted wireless communication link comprises establishing the first encrypted wireless communication link according to an encryption key, and the method further comprises:
forwarding the encryption key from the first WAP to a second WAP; and
establishing a second encrypted wireless communication link between the first device and the second WAP, using the encryption key forwarded from the first WAP to the second WAP.

8. The method of claim 1, further comprising:
receiving, at the first WAP, a second encrypted data packet from the first device via the first encrypted wireless communication link; and
decrypting, at the first WAP, the second encrypted data packet.

9. The method of claim 1, further comprising:
determining, at the first WAP, that the first encrypted data packet is destined for a destination node within the first LAN; and
in response to determining that the first encrypted data packet is destined for the destination node within the first LAN, performing the step of forwarding the first encrypted data packet from the first WAP to the first node within the first LAN, without decrypting the first encrypted data packet.

10. The method of claim 1, further comprising:
receiving, at the first WAP, a second encrypted data packet;
determining, at the first WAP, that the second encrypted data packet is destined for a destination node outside of the first LAN; and
in response to determining that the second encrypted data packet is destined for a destination node outside of the first LAN, decrypting the second encrypted data packet at the first WAP.

11. The method of claim 1, further comprising:
receiving, at the first WAP, a second encrypted data packet;
determining, at the first WAP, that the second encrypted data packet is destined for a destination node that does not have decryption capability; and
in response to determining that the second encrypted data packet is destined for a destination node that does not have decryption capability, decrypting the second encrypted data packet at the first WAP.

12. The method of claim 1, further comprising:
receiving, at the first WAP, a second encrypted data packet;
determining that an operating status of the first WAP meets a predetermined criterium; and
in response to determining that the operating status of the first WAP meets the predetermined criterium, decrypting the second encrypted data packet at the first WAP.

13. The method of claim 1, further comprising:
determining, at the first WAP, that the first encrypted data packet is a low-latency data packet; and
in response to determining that the first encrypted data packet is the low-latency data packet, performing the step of forwarding the first encrypted data packet from the first WAP to the first node within the first LAN, without decrypting the first encrypted data packet.

14. The method of claim 1, further comprising:
establishing, at the first WAP, a first unencrypted wireless communication link between the first WAP and a second device;
receiving, at the first WAP, a first unencrypted data packet from the second device via the first unencrypted wireless communication link; and
forwarding the first unencrypted data packet from the first WAP to the first node without encrypting the first unencrypted data packet.

15. The method of claim 1, wherein the first WAP comprises a WAP operating according to an Institute of Electrical and Electronics Engineers (IEEE) 802.11 standard.

16. The method of claim 15, wherein establishing the first encrypted wireless communication link comprises establishing the first encrypted wireless communication link according to one of a Wi-Fi Protected Access 2 (WPA2) protocol and a Wi-Fi Protected Access 3 (WPA3) protocol.

17. A thin wireless access point (WAP), comprising:
radio circuitry;
control circuitry configured to control the radio circuitry to:
receive a first encrypted data packet from a first node via a first wireless communication link between the thin WAP and the first node,
forward the first encrypted data packet from the thin WAP to a second node via a second wireless communication link between the thin WAP and the second node, without decrypting the first encrypted data packet,
receive a second encrypted data packet from the second node via the second wireless communication link, and
forward the second encrypted data packet from the thin WAP to the first node via the first wireless communication link, without decrypting the second encrypted data packet; and
power supply circuitry configured to provide electrical power to each of the radio transceiver circuitry and the control circuitry.

18. The thin WAP of claim 17, wherein the radio circuitry and the control circuitry are configured to collectively maintain each of the first wireless communication link and the second wireless communication link at the thin WAP according to an Institute of Electrical and Electronics Engineers (IEEE) 802.11 standard.

19. The thin WAP of claim 17, wherein the control circuitry is further configured to control the radio circuitry to operate the first and second wireless communication links on different respective wireless channels.

20. The thin WAP of claim 17, wherein the control circuitry is further configured to control the radio circuitry to operate the first and second wireless communication links at different respective radio frequencies.
